(19) United States
(12) Patent Application Publication
(10) Pub. No.: US 2026/0154966 A1
(43) Pub. Date: Jun. 4, 2026

(54) Systems And Methods For Processing Video To Determine Occupancy

(71) Applicant: Eaigle Inc., Markham (CA)

(72) Inventors: Akshaya Kumar MISHRA, Whitby (CA); Mahdi MARSOUSI, Maple (CA); Amir HOSSEIN, North York (CA)

(73) Assignee: Eaigle Inc., Markham (CA)

(21) Appl. No.: 18/964,139

(22) Filed: Nov. 29, 2024

(51) Int. Cl. G06V 20/52; G06T 3/40

(52) U.S. Cl. CPC G06V 20/53; G06T 3/40

(57) ABSTRACT

System and method for processing video. The method includes receiving at least one set of visual information of a scene; processing the at least one set of visual information with a first machine learning process to determine the presence of one or more objects in the scene. The method also includes processing visual information of the at least one set of visual information corresponding to the presence of the one or more objects to determine, for each object, a partition location, wherein the partition location is based on a model dividing the scene into a plurality of partitions; and determining an occupancy within the scene based on the determined partitions.

### TECHNICAL FIELD

This application relates to systems and methods for detecting and monitoring occupancy in physical environments.

### BACKGROUND

Processing video to determine occupancy is used in a variety of practical applications, including, for example, smart buildings, traffic management, security, public safety, and industrial automation. Occupancy determination can be used to not only detect, but to continually monitor occupancy in a space.

Traditional occupancy detection systems rely on fixed grids and simple sensor data, which are often inadequate for handling the dynamic and complex nature of real-world environments. For example, radar-based systems can detect and track individuals but struggle with identification and re-identification. Software-defined radio (SDR) technology is flexible but may lack the features necessary for accurate occupancy monitoring. Moreover, traditional vision systems using stereo cameras require expensive and complex setups, making them impractical for widespread use in many environments. Improvement is desirable.

### SUMMARY

In one aspect, there is provided a method for processing video comprising: receiving at least one set of visual information of a scene; processing the at least one set of visual information with a first machine learning process to determine the presence of one or more objects in the scene; processing visual information of the at least one set of visual information corresponding to the presence of the one or more objects to determine, for each object, a partition location, wherein the partition location is based on a model dividing the scene into a plurality of partitions; and determining an occupancy within the scene based on the determined partitions.

In certain example embodiments, wherein the model divides the plurality of grid locations into a plurality of zones, and wherein processing the at least one set of visual information with the first machine learning process comprises: processing the at least one set of visual information on a per zone basis.

In certain example embodiments, the method includes generating a graphical representation of the determined occupancy based on the determined grid locations.

In certain example embodiments, the method includes generating the model based on training visual information of the scene.

In certain example embodiments, the training visual information is a map or computer aided design model.

In certain example embodiments, the training visual information is an offline video, and generating the model comprises: processing the training visual information with an object detector to determine the presence of objects in frames of the video; generating a heatmap based on an estimated position of the determined objects; determining the model based on the heatmap.

In certain example embodiments, the method further includes converting the heatmap to a binary image; and determining the model based on the binary heatmap.

In certain example embodiments, converting of the heatmap to the binary image comprises applying a threshold.

In certain example embodiments, the method further includes generating the heatmap in response to determining the heatmap is saturated.

In certain example embodiments, the method further includes applying a contouring algorithm to the heatmap to generate the model.

In another aspect, there is provided a method for processing video to determine occupancy comprising: receiving at least one set of visual information of a scene; processing the at least one set of visual information with a first machine learning process to determine the presence of one or more objects in the scene; processing visual information of the at least one set of visual information corresponding to the presence of the one or more objects with a touchpoint model to determine, for each object, an object-surface interaction; and determining an occupancy within the scene based on the object-surface interactions.

In certain example embodiments, processing visual information of the at least one set of visual information corresponding to the presence of the one or more objects with the touchpoint model comprises: isolating the visual information of the at least one set of visual information corresponding to each of the detected objects; and separately processing each isolated visual information set with the touchpoint model.

In certain example embodiments, to determine the isolated visual information set, the method comprises, for each detected object: processing the at least one visual information corresponding to the presence of the detected object set with an alignment model to crop or resize the visual information.

In certain example embodiments, further comprising: generating synthetic training data for training the first machine learning process and the touchpoint model by: occluding at least one touchpoint location of an object in a training sample.

In certain example embodiments, further comprising: generating synthetic training data for training the first machine learning process and the touchpoint model by: occluding at least one location other than a touchpoint location of an object in a training sample.

In certain example embodiments, a truth associated with the occluded training sample is a center location of the foot, further comprising processing the training visual information with an object detector to determine the presence of objects in frames of the video; generating a heatmap based on an estimated position of the determined objects; and determining the model based on the heatmap.

In certain example embodiments, the method further includes converting the heatmap to a binary image; and determining the model based on the binary heatmap.

In certain example embodiments, converting of the heatmap to the binary image comprises applying a threshold.

In certain example embodiments, the method further includes generating the heatmap in response to determining the heatmap is saturated.

In certain example embodiments, the method further includes applying a contouring algorithm to the heatmap to generate the model.

In certain example embodiments, the method further includes receiving a second set of images of the vehicle from the one or more imaging devices; with the machine vision model, at least in part determining a presence of the vehicle in the second set of images; determining a duration the vehicle spent inside a region based on the plurality of images and the second set of images; and generating an invoice based on the determined duration.

In other aspects, there are provided systems having imaging devices, processor and memory and computer readable media storing computer-executable instructions for performing the methods.

### BRIEF DESCRIPTION OF THE DRAWINGS

Embodiments will now be described with reference to the appended drawings wherein:

FIG. 1a is a block diagram illustrating an example of a configuration for processing imaging data.

FIG. 1b is a block diagram illustrating an example of another configuration for processing imaging data.

FIG. 2 is a block diagram illustrating an example of a configuration for an image processor.

FIG. 3 is a flow chart illustrating example operations performed in updating the occupancy status of occupancy grids.

FIG. 4 is a flow chart illustrating example operations performed in creating an occupancy grid.

FIG. 5 illustrates a technique for measuring a foot location relative to a bounding box.

FIG. 6(a) to 6(c) illustrate a technique for performing a foot location prediction in multiple example scenarios.

FIG. 7 illustrates a training stage for a generic object detector used with a foot location predictor.

FIG. 8 illustrates a feature extraction procedure and foot location predictor network.

FIG. 9 illustrates and example of a convolution operation.

FIG. 10 illustrates an inference stage of the generic object detector used with the foot location predictor.

FIG. 11 illustrates a foot location predictor using a Y-net and multi-task learning.

FIG. 12 provides flow charts illustrating mixed mode training sample generation.

FIGS. 13a and 13b illustrate a training sample creation procedure.

FIG. 14a illustrates example layouts.

FIG. 14b illustrates example grids.

FIG. 14c illustrates example object detection outputs.

FIGS. 15a and 15b provide additional examples of detected grids.

### DETAILED DESCRIPTION

Described herein is at least one approach that can generate real-time occupancy estimation. The approach may include dividing physical layouts into deformable grids or lattices and leverages advanced sensing technologies and artificial intelligence (AI) to provide accurate and scalable solutions across various environments.

The proposed methodology provides techniques to estimate the occupancy status of a physical layout by dividing the physical layout into a number of linear or non-linear or elastic deformable grids/lattices. The proposed methods employ sensors such as a camera and/or radar to obtain static images or videos of the physical layout and incidences occurring on the physical layout. The proposed methods may use advanced image processing, computer vision, pattern recognition and modern AI technology to obtain the occupancy status of each grid/lattice in real-time. The occupancy status can be represented in a discrete format at each time stamp or can be averaged over a period using advance data integration methods.

The map of occupancy grid can be drawn using human inputs or can be constructed using statistical analysis of large amount of historical occupant data captured at from the physical location overall a predefine period.

Once a layout of the occupant grid is created, one can place several sensors to cover the occupant grids, then the sensor input is fed to occupancy monitoring systems to determine occupancy status of each grid.

Example occupants include, without limitation, human, animals, spills, smoke, retail items on a shelf, inventory, vehicles, etc.

Example applications include, without limitation, the number of swimmers in a swimming pool, the number of people in a meeting room, occupancy status of a swimming pool, whether a physical location is occupied with spills, whether a physical location is occupied with smoke, whether an exit gate is blocked by a foreign object, how long a vehicle is parked in a parking lot, how full is a truck, etc.

Example sensors include, without limitation, red-green-blue (RGB), infrared (IR) and thermal cameras, radar, sonar, etc.

Example technologies include change detection based on motion, color and texture, object detection technologies using deep learning, multiple-object tracking, object localization, object registration.

For each type of occupant, the system described herein can define a set of key points that touches the ground. The system may then estimate the position of these key points in two-dimensional (2D) image planes. A RGB camera and radar may then, in one example, be used to create 2D images. The system may also employ deep learning methods, such as Yolo, Y-net and U-net as a 2D key point estimator.

The system may also be configured to project the 2D key points to 3D planes by assuming the z-coordinates as zero (because key points touch the ground). Using PnP and homogeneity metrics, the system can find the correspondence between 2D key points and 3D key points.

For multi-camera settings, the system can project the 2D key points of each 2D image to the 3D layouts, then fuse the 3D key points based on spatial overlap. These and other features are described in greater detail below making reference to the figures.

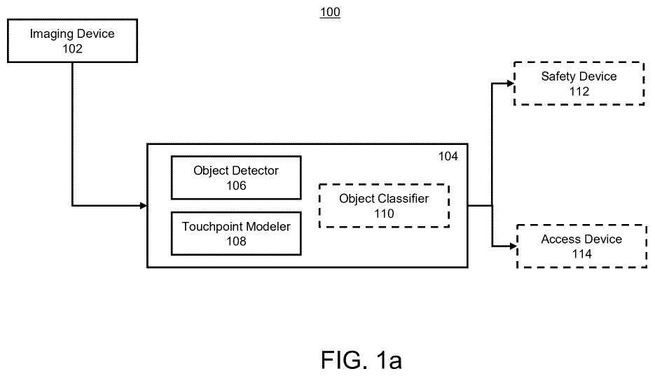

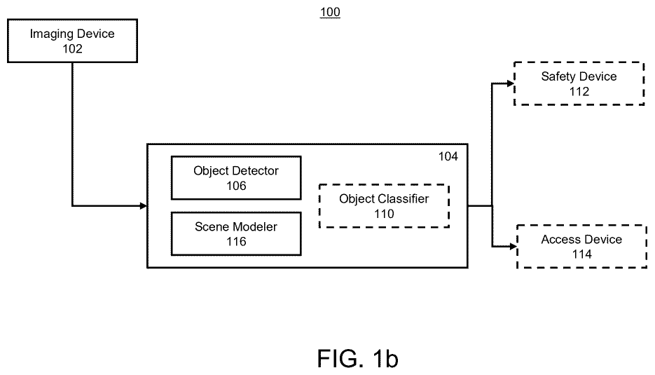

Referring now to the figures, FIG. 1a shows an example system 100 for processing visual information such as images and/or video, which includes a series of images. The illustrated example system 100 includes one or more imaging device(s) 102 (shown and referred to in the singular, for ease of reference) that generate the visual information, and an image processor 104 that is configured to process images and/or video.

Various types of imaging devices 102 are contemplated by this disclosure. The imaging device 102 can be an RGB camera, a thermal camera, an infrared camera, etc. Combinations of imaging devices 102 are also contemplated. For example, the imaging device 102 can include a first thermal camera, and three other RGB cameras.

The imaging device 102 captures visual information related to a scene. The scene (not shown) is understood to be a region of interest, which can include objects (e.g., people, cars, merchandise), and other features (ground, hills, sky, etc.). The imaging device 102 can be focused on a particular aspect of the scene (e.g., a particular portion), for example in instances where multiple imaging devices 102 are used to ensure coverage of an entire scene.

The image processor 104 can include a plurality of components. In the example shown in FIG. 1a, the image processor 104 includes an object detector 106, a touchpoint modeler 108, and optionally an object classifier 110. The object detector 106 can detect objects in the visual information (e.g., an image, a video, etc.) provided by the imaging device 102. The object detector 106 can also generate or result in a subset of the visual data processed or amend or otherwise append features to the visual data being processed. For example, the object detector 106 can generate a bounding box around any detected objects in the visual data.

The touchpoint modeler 108 can receive visual data that includes a detected object. For example, the touchpoint modeler 108 can receive a subset of the visual data with the detected object from the object detector 106, or indication of the bounding box, etc. The touchpoint modeler 108 determines a location where an object interacts with a non-object (e.g., the ground). That is, the touchpoint modeler 108 determines the points of the object (which is capable of movement) on non-objects (i.e., features that do not move). An example includes the touchpoint modeler 108 determining where a person object interacts, or stands on, a floor within a store.

The image processor 104 can, optionally, include an object classifier 110. The object classifier 110 can determine the type of object (e.g., person, car, bike, etc.), and/or features of an object (e.g., a trailer number, a license place, etc.). Various types of object classifiers 110 are contemplated by this disclosure, as well as implementations that include more than one object classifier (e.g., a first classifier to determine whether the visual information includes a truck, and a second to determine the license plate number).

The system 100 can include one or more downstream devices. In the example shown in FIG. 1a, the system 100 can optionally include a safety device 112, and an access device 114. The safety device 112 can include a variety of different devices, such as alarms, lights, etc. The access device 114 can include devices such as locking doors, gates, etc. The system 100 can be configured to, in response to detecting occupancy greater or lower than a threshold, activate or otherwise control the safety device 112 or the access device 114. For example, the access device 114 can be used to lock doors to prevent over-occupancy or to avoid areas where there are spills or other hazards. Similarly, the safety devices 112 can be activated to provide warning to, or alleviate, any hazards. Various other downstream devices may be coupled to or integrated into the system 100 to enable the image processing discussed herein to be applied to a real-world device, system or application.

In the embodiment shown in FIG. 1b, the image processor 104 includes a scene modeler 116. The scene modeler 116 can be used to generate a model that partitions the scene into a plurality of partitions, or to apply an existing model to impose or process visual information with a framework based on the plurality of partitions in the existing model. For example, the partitions can be grid-like, in that they divide the scene into a plurality of rectangular sub-sections. The scene modeler 116 can be used to generate the aforementioned model.

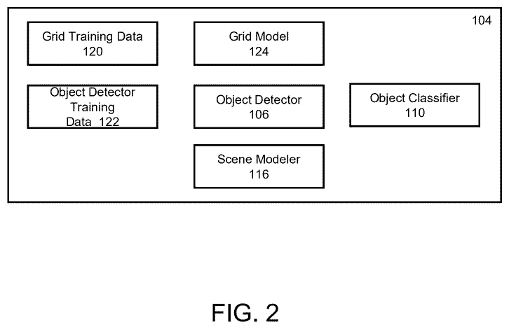

Referring now to FIG. 2, an example of a configuration for the image processor 104 is shown. The image processor 104 may include the object detector 106 and object classifier 110 as shown in FIGS. 1a and 1b as well as grid training data 120, object detector training data 122, and a grid model 124. In this example, the image processor 104 also includes the scene modeler 116. As explained in greater detail below, the grid training data 120 is used to train the grid model 124. The object detector training data 122 may also be used in training the grid model 124 or another object detection model (not shown) that is used with the grid model 124 to perform processes described herein.

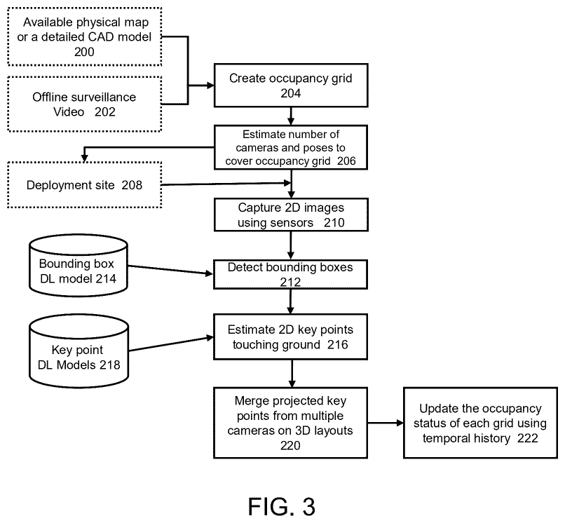

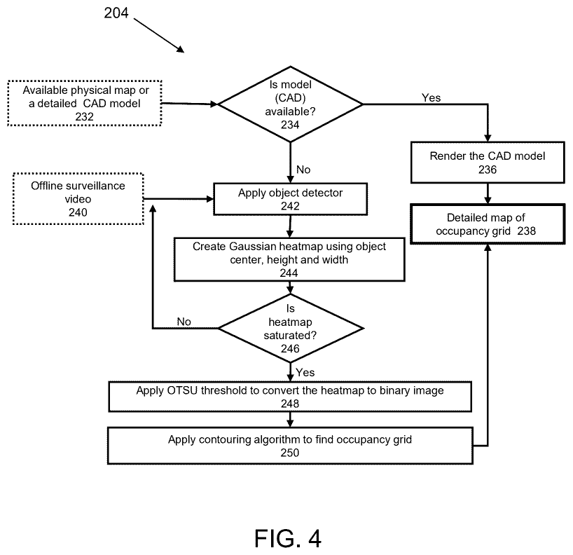

FIG. 3 illustrates example operations that may be performed in updating the occupancy status of occupancy grids. The occupancy grid is created at step 204, further detail of which is provided below in connection with FIG. 4. At step 200, if available, the system can obtain a physical map or a detailed computer-aided drawing (CAD) model, blueprint or other layout of the observed area. Additionally or alternatively, the system may obtain offline surveillance video at step 202, which includes footage of the observed area from which the occupancy grid may be created at step 204, as discussed below.

At step 206, the system estimates the number of cameras and poses that would be needed to cover the occupancy grid. Step 208 may be performed, if necessary, to access the deployment site in order to make the estimates at step 206.

At step 210, the cameras and/or other sensors are used to capture 2D images. From the captured images, one or more bounding boxes may be detected at step 212. The bounding boxes may be detected using a bounding box deep learning (DL) model 214, which may be trained and utilized for inference as described by way of example below.

At step 216, the system estimates 2D key points that are determined to be touching the ground/floor or other underlying surface. This may be done by accessing key point DL models 218. At step 220, the system merges the projected key points from multiple cameras on 3D layouts, that is, to determine in which bounding box the key points suggest a subject is touching the ground. At step 222, the system updates the occupancy status of each grid using the temporal history. The temporal history refers to tracking the presence of an occupant over time. In this way, the system may then report the occupancy status over an interval, for example, an occupancy status every one minute, 15 minutes, 30 minutes, hourly, daily, weekly, etc., based on customer requirements.

FIG. 4 illustrates example operations that may be performed in creating an occupancy grid, e.g., at step 204 in FIG. 3. At step 234, the system determines if a model (e.g., CAD, blueprint, etc.) is available. If so, the detailed model may have been provided to the system or obtained by the system at step 232. If the model is available, at step 236 the system renders the model and, at step 238, creates a detailed map of the occupancy grid. If the model is not available, the system may need to acquire the offline surveillance video at step 240.

At step 242, the video is processed by applying an object detector. Then, at step 244, a Gaussian heatmap may be created using the object center, height, and width as described further below. The system determines at step 246 if the heatmap is saturated. If not, the object detector may be applied again at step 242. Once the heatmap is saturated, the system may apply an Otsu threshold at step 248, to convert the heatmap to a binary image. At step 250, the system applies a contouring algorithm to find the occupancy grid, which is used to create the detailed map of the occupancy grid at step 238.

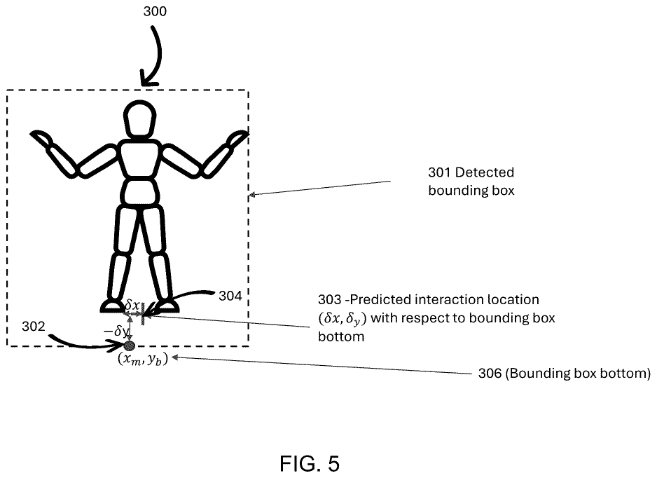

Referring now to FIG. 5, a foot location determination with respect to a bounding box 300 is shown. An image that includes an occupant may be input to a deep learning (DL) model to predict the location of the occupant's foot with respect to the lower boundary (i.e. center point 302 in this example) of the bounding box 300. The bounding box 300 may be detected using an object detection algorithm such as You Only Look Once (YOLO) or similar algorithm(s). The center 302 provides a (0,0) reference set of coordinates. The bounding box 300, which is used to define one of the grids in the image is analyzed to determine occupancy. In this case, the foot location 304 of a detected subject is determined to see if that subject is touching the floor and thus is an occupant of the scene. Here, δx is measured at location 304 from a position that is located between the feet. Moreover, δy is the distance from the subject's feet/foot to the bottom of the bounding box 302. The pair (δx, δy) is the predicted interaction location 303 with respect to the bounding box center 302. The bounding box bottom 306 is measured at (xₘ, y_{b}) relative to the original image or scene top left position (as seen in figure). For the foot location, the point is estimated with respect to (xₘ, y_{b}). The DL model may therefore receive an image of a person and generate the pair (δx, δy), wherein −1<δx and δy<1.

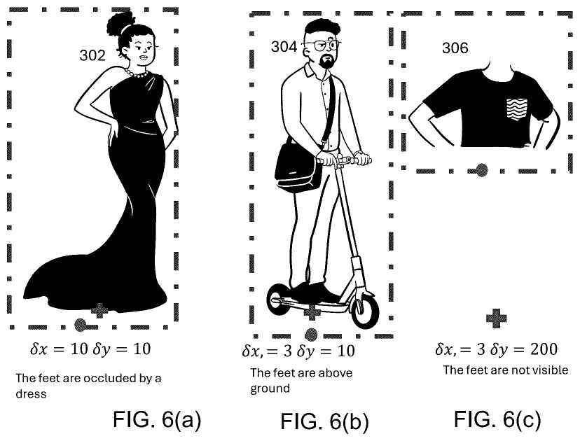

FIG. 6(a) through 6(c) illustrate feet location prediction in various scenarios. In FIG. 6(a), the feet are occluded by a dress, and are estimated to be at δx=10 and δy=10 relative to the bottom of the bounding box 302. In FIG. 6(b), the feet are determined to be above the ground (in this example riding a scooter), with and are estimated to be at δx=3 and δy=10 relative to the bottom of the bounding box 304. In FIG. 6(c), the feet are not visible as they are cut off in the bounding box. Here, the feet are estimated to be at δx=3 and δy=200 relative to the bottom of the bounding box 306. Further detail regarding the processes for performing the detections shown in FIGS. 5 and 6 are described later. When collecting a dataset, samples of humans with most key points visible are processed to determine their connection to the ground. To simulate occlusion scenarios (where a human foot is obscured), a random portion is cropped from the bottom of the image. The cropped image serves as the input, while the true foot location is used as the ground truth. In essence, the foot location is extrapolated from partial human data.

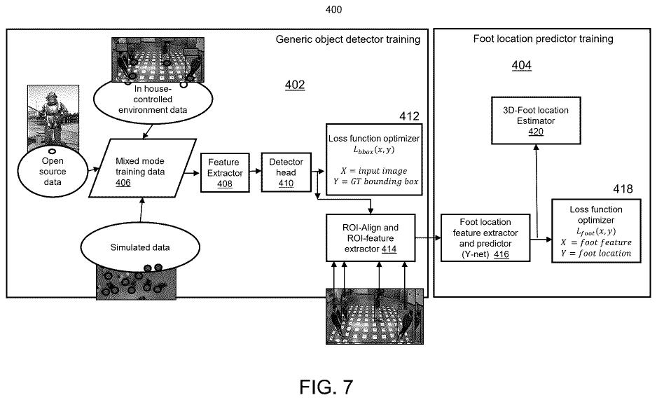

FIG. 7 illustrates a module 400 that is configured to perform the training stage of a generic object detector (402) and to perform foot location predictor training (404). In one example, the foot location predictor 404 may be frozen until the object detector 402 is trained until convergence. Then, the foot location predictor 404 and the object detector 402 may be trained together until convergence.

In the object detector training stage 402, various types of data may be obtained to create a collection of mixed mode training data 406. In this example, in-house controlled environment data 406a, open source or otherwise publicly available data 406b, and simulated data 406c may be collected and fed to a feature extractor 408. The results of the feature extractor 408 are fed to a detector head 410. It may be noted that in deep learning, there are three main network components, namely the backbone (feature extractor), neck (which fuses the features), and detector head 410. The detector head 410 makes the decisions, such as predicting object boundaries, object class names, and object confidence. The output of the detector head 410 is fed to a loss function optimizer 412, which optimizes for the loss function L_{bbox}(x, y), where X=input image and Y=¿boundingbox, wherein GT refers to the ground truth, namely the points annotated by a human The output of the detector head 410 is also fed to a region of interest (ROI) align and ROI-feature extractor 414, which also ingests in-house controlled data.

The output of the feature extractor 414 is fed into the foot location predictor training 404 once the object detector training 402 reaches convergence. In the foot location predictor training 404, a foot location feature extractor and predictor (Y-net) 416 is performed and is fed to a loss function optimizer 418 L_{foot}(x, y), where X=foot feature and Y=foot location. The output of the extractor and predictor 416 is also fed to a 3D-foot location estimator 420.

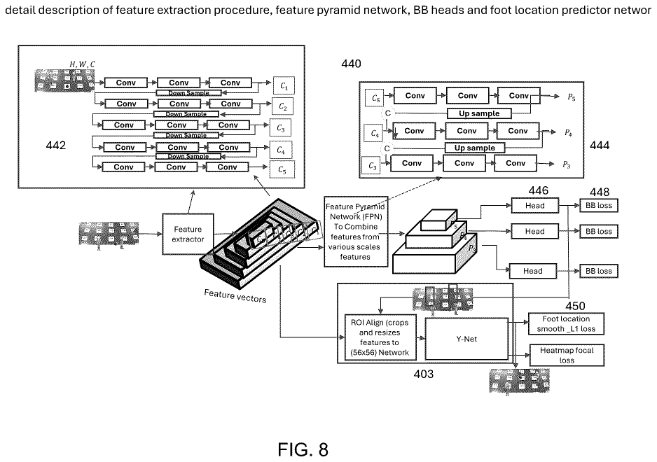

FIG. 8 illustrates the overall architecture of object detection and foot location estimations. Similar to many modern object detection solutions, the generic object detector has three main components, back-bone feature extractor, feature pyramid network, a neck, and a head. Block 442 describes a multi-resolution feature extractor network, the network uses a sequence of convolutions and down sampling operations to obtain features at various scales and resolutions, e.g., C1, C2, C3, C4 and C5 are features at various scales and resolutions.

For instance, an image of size 512×512, size of C1, C2, C3, C4 and C 5 are 256×256×n_d, 128×128×n_d, 64×64×n_d, 32×32×n_d, 16×16×n_d. Where n_d is the number of features. Typically, the feature extractor is also known as backbone or encoder network. Blocks 440, 444 represent a feature pyramid network, also known as decoder network. P3, P4 and P5 represent the decoded features at 3 different scales. P3 represents small objects, P4 represents medium size objects and P5 represents large objects. P3, P4 and P5 are feed to head network, typically represented using fully convolution network (FC) or multi-layer perceptron. The head network (446) predicts the object boundaries. The predicted boundaries are then compared with the ground truth boundary using smooth L1 loss, denotes this as BB loss (448) in FIG. 8.

Once the network is trained to predict object boundaries correctly, the system uses a region pooling and alignment network to extract features local to object boundaries using the predicted bounding box and backbone features. These features are fed to a Y-net, whose goal is to predict foot locations. Foot locations are represented using discrete coordinates as well as a continuous heat-map. The system uses smooth L1 loss for predicting discrete foot locations and focal loss to predict continuous heatmap representation of the foot locations.

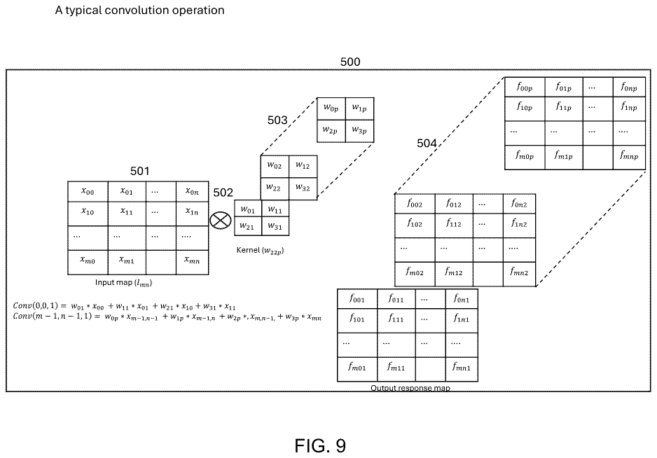

FIG. 9 illustrates the fundamental process of a convolution operation, which utilizes a linear weighted averaging function. This operation is applied across multiple layers to extract feature responses at varying scales.

Block 501 represents an input feature map, which can either be the original image or the output from a preceding layer in the network. This serves as the starting point for the convolution process.

Blocks 502 and 503 depict the weights or kernels used during the convolution operation. These kernels are small, learnable filters that slide across the input map to compute the weighted sum of the input values within the kernel's receptive field.

Block 504 shows the resulting output feature map. This is obtained by convolving the input feature map (block 501) with the kernels (blocks 502 and 503). The output represents the response of the input to the applied kernels, highlighting specific patterns or features such as edges, textures, or other critical image characteristics.

This process is an important part of convolutional neural networks (CNNs), enabling the extraction of hierarchical features that become increasingly abstract as they propagate through successive layers.

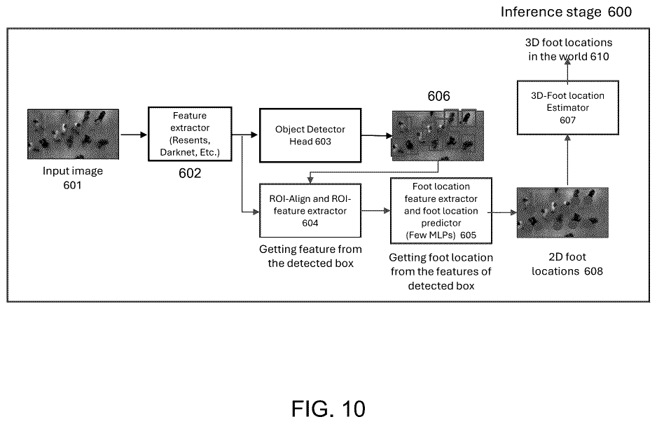

FIG. 10 illustrates the inference stage 600 of a generic object detector and foot location predictor, detailing the sequential flow of operations used to detect and locate foot positions in both 2D and 3D.

Input Image (601). The process begins with an input image 601, which serves as the raw data for object detection and foot location estimation.

Feature Extraction (602): The input image 601 is processed by a feature extractor 602, such as ResNet or Darknet, to generate feature maps. These extracted features represent key image details, such as edges, textures, and object patterns, necessary for downstream processing.

Object Detection Head (603): The extracted features 602 are passed to the object detector head 603, which identifies and localizes objects within the input image. This step outputs bounding boxes 606 that mark the detected objects (e.g., people).

ROI Align and Feature Extraction (604): Using the bounding boxes 606 from the object detector 603, ROI Align 604 is applied to crop and align the features from the detected object regions. These features are refined to focus on the detected bounding boxes 606 and are used as input for the foot location predictor.

Foot Location Prediction (2D)—605: The cropped and aligned features are passed to a foot location feature extractor and predictor 605, implemented using a few multi-layer perceptrons (MLPs). This network predicts the 2D foot locations within the bounding boxes 606, resulting in a set of foot coordinates 608 overlaid on the image.

3D Foot Location Estimation (607): The 2D foot locations 608 are then fed into a 3D foot location estimator 607, which transforms the 2D coordinates into 3D positions in the world space 610. This stage leverages additional depth information or calibration data to estimate the 3D positions of the feet accurately.

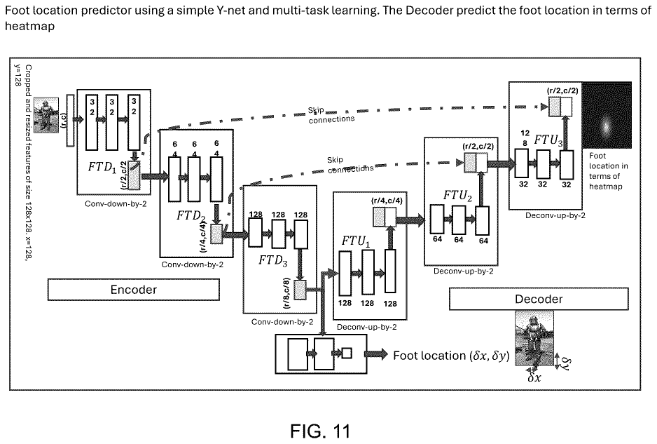

FIG. 11 illustrates the architecture of a foot location predictor using a standard Y-Net structure and multi-task learning. The network includes an encoder-decoder design to predict foot locations in terms of both discrete coordinates (δx, δy) and a continuous heatmap representation.

Input Features: The input to the network includes cropped and resized features of size 128×128×r, where r represents the number of feature channels. These features are derived from the detected regions of interest.

Encoder Network (Left Side): The encoder progressively compresses the input feature map by performing a series of convolutional and down-sampling operations:
FTD 1: The first encoder block reduces the spatial resolution by a factor of 2 while increasing the depth (channel count) by r/2.
FTD2: The second block further downsamples the feature map, reducing the spatial size by another factor of 2 while increasing the depth to r/4.
FTD3: The final encoder block reduces the spatial size again, with the feature depth now r/8.

The encoder captures hierarchical features at multiple scales and resolutions.

Decoder Network (Right Side): The decoder reconstructs the feature map from the compressed representation, using a sequence of deconvolution (up-sampling) operations:
FTU1: Upsamples the feature map, restoring spatial size and reducing the depth to r/4
FTU2: Further upsampling restores the spatial size while reducing the depth to r/2.
FTU3: The final block upsamples the feature map to the original spatial size, with the depth matching the initial input resolution.

Skip connections are utilized between corresponding encoder and decoder layers to preserve fine-grained details.

Output Predictions: The network outputs two forms of foot location predictions:
Discrete Coordinates (δx, δy): A dense layer processes the final features to predict precise foot locations in terms of discrete x and y offsets.
Continuous Heatmap: A heatmap is generated to represent the likelihood of foot locations spatially. The heatmap highlights areas of high confidence for the detected foot positions.
Multi-task Learning: The model is trained jointly for both tasks (discrete and continuous predictions), enabling robust performance. Loss functions like Smooth L1 Loss for coordinates and Focal Loss for the heatmap are employed to optimize the network.

This diagram demonstrates a compact yet effective approach to foot location prediction, combining the strengths of both discrete and continuous representations while leveraging encoder-decoder efficiency and skip connections.

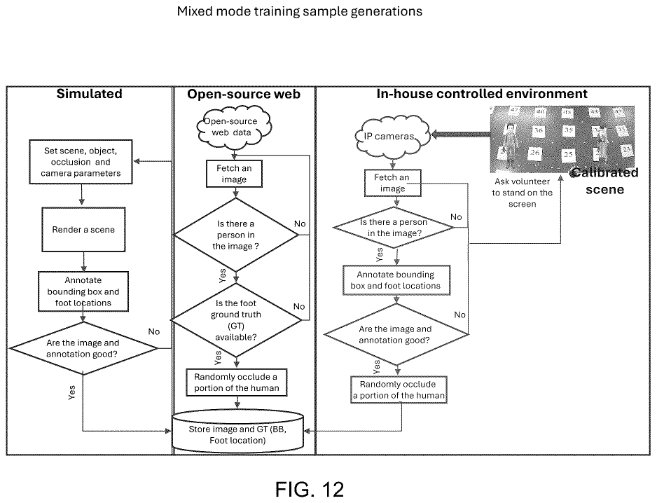

FIG. 12 illustrates a mixed-mode approach for generating training samples, combining simulated data, open-source web data, and data captured in an in-house controlled environment. Each mode contributes to building a robust and diverse dataset for object detection and foot location tasks.

### 1. Simulated Data Generation

Step 1: Scene setup is initiated by defining parameters such as scene layout, object placement, occlusion conditions, and camera configurations.

Step 2: A virtual scene is rendered based on the setup parameters.

Step 3: Bounding boxes and foot locations are annotated for objects in the rendered scene.

Step 4: The generated image and its annotations are validated. If the quality is deemed insufficient, the process loops back to adjust parameters and re-render the scene.

Step 5: Upon successful validation, the image and its annotations are stored as part of the dataset.

### 2. Open-Source Web Data

Step 1: Images are fetched from open-source web data repositories.

Step 2: Each image is checked to determine if it contains a person: If no person is detected, the image is discarded.

Step 3: If a person is present, the availability of ground truth (GT) annotations for foot locations is checked: If no GT is available, the image is discarded.

Step 4: When GT annotations are available, a portion of the human figure is randomly occluded to introduce variability.

Step 5: The modified image and its ground truth (bounding boxes and foot locations) are stored in the dataset.

### 3. In-House Controlled Environment Data

Step 1: Images are captured in a calibrated environment using IP cameras.

Step 2: A volunteer is asked to stand in the calibrated scene to ensure consistent positioning and setup.

Step 3: Each captured image is checked to determine if it contains a person: If no person is detected, the image is discarded.

Step 4: Bounding boxes and foot locations are annotated for detected persons in the image.

Step 5: The annotated images are validated for quality: If the quality is insufficient, the process loops back to capture a new image.

Step 6: To increase variability, portions of the human figure may be randomly occluded.

Step 7: The validated image and its annotations are stored in the dataset.

This mixed-mode data generation strategy ensures diversity and robustness by leveraging simulated environments, publicly available data, and controlled in-house setups. Each method complements the others, providing a wide range of scenarios for training object detection and foot location models.

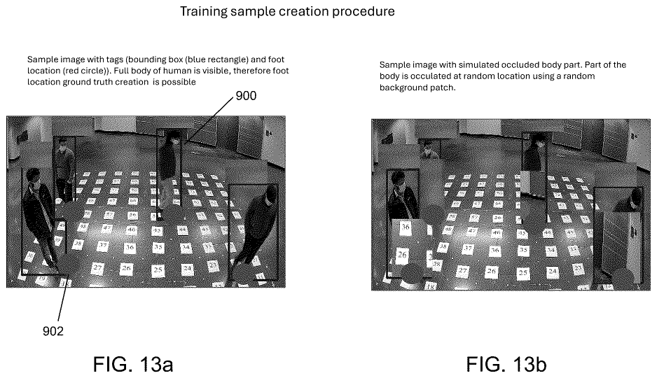

FIG. 13a illustrates a sample image with tags (bounding boxes 900) and foot locations (circles 902). In this example, full bodies of humans are visible, therefore the foot ground location is possible. In FIG. 13b, the same sample image is shown with occluded body parts. Part of the body is occluded at a random location using a random background patch.

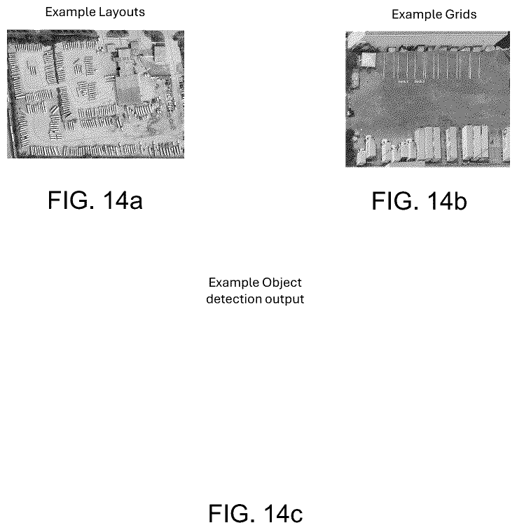

FIG. 14a illustrates an example layout, FIG. 14b an example grid, and FIG. 14c an example object detection output for truck trailers in an image.

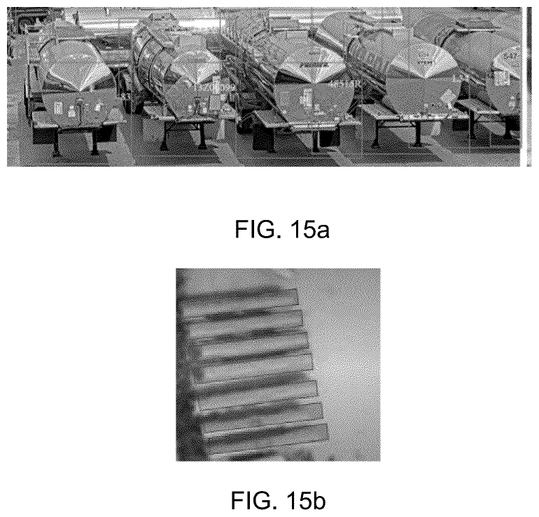

FIGS. 15a and 15b provide additional examples of objects identified using bounding boxes.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the systems described herein, related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order or in parallel, or steps may be added, deleted, or modified.

Although the above principles have been described with reference to certain specific examples, various modifications thereof will be apparent to those skilled in the art as having regard to the appended claims in view of the specification as a whole.

1. A method for processing video comprising:
receiving at least one set of visual information of a scene;
processing the at least one set of visual information with a first machine learning process to determine the presence of one or more objects in the scene;
processing visual information of the at least one set of visual information corresponding to the presence of the one or more objects to determine, for each object, a partition location, wherein the partition location is based on a model dividing the scene into a plurality of partitions; and
determining an occupancy within the scene based on the determined partitions.

2. The method of claim 1,
wherein the model divides the plurality of grid locations into a plurality of zones, and wherein processing the at least one set of visual information with the first machine learning process comprises:
processing the at least one set of visual information on a per zone basis.

3. The method of claim 1, comprising:
generating a graphical representation of the determined occupancy based on the determined grid locations.

4. The method of claim 1, comprising:
generating the model based on training visual information of the scene.

5. The method of claim 4, wherein the training visual information is a map or computer aided design model.

6. The method of claim 4, wherein the training visual information is an offline video, and generating the model comprises:
processing the training visual information with an object detector to determine the presence of objects in frames of the video;
generating a heatmap based on an estimated position of the determined objects;
determining the model based on the heatmap.

7. The method of claim 6, further comprising:
converting the heatmap to a binary image; and
determining the model based on the binary heatmap.

8. The method of claim 7, wherein converting of the heatmap to the binary image comprises applying a threshold.

9. The method of claim 6, comprising:
generating the heatmap in response to determining the heatmap is saturated.

10. The method of claim 7, comprising:
applying a contouring algorithm to the heatmap to generate the model.

11. A method for processing video to determine occupancy comprising:
receiving at least one set of visual information of a scene;
processing the at least one set of visual information with a first machine learning process to determine the presence of one or more objects in the scene;
processing visual information of the at least one set of visual information corresponding to the presence of the one or more objects with a touchpoint model to determine, for each object, an object-surface interaction;
determining an occupancy within the scene based on the object-surface interactions.

12. The method of claim 11, wherein processing visual information of the at least one set of visual information corresponding to the presence of the one or more objects with the touchpoint model comprises:
isolating the visual information of the at least one set of visual information corresponding to each of the detected objects; and
separately processing each isolated visual information set with the touchpoint model.

13. The method of claim 12, wherein to determine the isolated visual information set, the method comprises, for each detected object:
Processing the at least one visual information corresponding to the presence of the detected object set with an alignment model to crop or resize the visual information.

14. The method of claim 11, comprising:
generating synthetic training data for training the first machine learning process and the touchpoint model by:
occluding at least one touchpoint location of an object in a training sample.

15. The method of claim 11, comprising:
generating synthetic training data for training the first machine learning process and the touchpoint model by:
occluding at least one location other than a touchpoint location of an object in a training sample.

16. The method of claim 14, wherein a truth associated with the occluded training sample is a center location of the foot;
processing the training visual information with an object detector to determine the presence of objects in frames of the video;
generating a heatmap based on an estimated position of the determined objects;
determining the model based on the heatmap.

17. The method of claim 16, further comprising:
converting the heatmap to a binary image; and
determining the model based on the binary heatmap.

18. The method of claim 17, comprising:
applying a contouring algorithm to the heatmap to generate the model.

19. The method of claim 11, comprising:
receiving a second set of images of the vehicle from the one or more imaging devices;
with the machine vision model, at least in part determining a presence of the vehicle in the second set of images;
determining a duration the vehicle spent inside a region based on the plurality of images and the second set of images; and
generating an invoice based on the determined duration.

20. A system for processing video to determine occupancy, the system comprising:
one or more imaging devices;
a processor; and
a memory, in communication with the processor and one or more imaging devices, the memory storing computer executable instructions that when executed by the processor, cause the system to:
receive at least one set of visual information of a scene;
process the at least one set of visual information with a first machine learning process to determine the presence of one or more objects in the scene;
process visual information of the at least one set of visual information corresponding to the presence of the one or more objects to determine, for each object, a partition location, wherein the partition location is based on a model dividing the scene into a plurality of partitions; and
determine an occupancy within the scene based on the determined partitions.
